(19) United States
(12) Patent Application Publication
(10) Pub. No.: US 2003/0209016 A1
(43) Pub. Date: Nov. 13, 2003

(54) Method and system for supplying vaporized gas on consumer demand

(75) Inventor: Gadi Sicherman, Hoshaya (IL)

Correspondence Address: DR, MARK FRIEDMAN LTD., c/o Bill Polkinghorn, Discovery Dispatch, 9003 Florin Way, Upper Marlboro, MD, 20772, US

(73) Assignee: ExTA Exclusive Thermodynamic Applications Ltd.

(21) Appl. No.: 10/396,447

(22) Filed: Mar. 26, 2003

Related U.S. Application Data
(63) Continuation-in-part of application No. 09/674,700, filed on Nov. 6, 2000, now Pat. No. 6,470,690.
(63) Continuation-in-part of application No. 10/108,450, filed on Mar. 29, 2002, now Pat. No. 6,578,365.

(51) Int. Cl. F17C 7/04; F17C 9/02

(52) U.S. Cl. 62/50.2; 62/48.1

(57) ABSTRACT

A method for supplying a vaporized gas, including: (a) providing a system having: (i) a storage tank for storing liquefied gas; (ii) a heat exchanger external to the tank, disposed in a heat-exchange relationship with a wall of the tank; (iii) a device for delivering a heat-exchange liquid from a reservoir to the heat exchanger, and (iv) a delivery line for directly transferring the vaporized gas from the heat exchanger to the consumer; (b) supplying the vaporized gas directly to the consumer, according to consumer demand; (c) upon vaporization of a portion of the liquefied gas within the storage tank, and subsequent cooling of the liquefied gas within the storage tank, transferring heat from the heat-exchange liquid to the tank via the heat exchanger, so as to increase the tank pressure.

This is a continuation-in-part (CIP) of U.S. patent application Ser. No. 09/674,700, filed Nov. 6, 2000, now U.S. Pat. No. 6,470,690, and U.S. patent application Ser. No. 10/108,450, filed Mar. 29, 2002.

### FIELD AND BACKGROUND OF THE INVENTION

The present invention relates to a method and a system for supplying pressurized gas from a liquefied-gas (LG) storage tank.

LG systems are widely used in residential, agricultural, and industrial settings and they are expected to be a reliable source of energy, to operate safely, continuously, and to constantly supply guaranteed output. One critical performance criterion of LG systems is the delivery of a constant, stable and reliable flow of vaporized gas to the burners.

Some commonly used systems and methods of vaporization employ over-capacity storage tanks and vaporizers. The over-capacity storage tanks are expensive and provide inconsistent vapor pressure, especially during extreme ambient conditions. They also waste space, call for surplus gas stock and unnecessarily large and expensive storage area.

In one known system, the heat of vaporization is supplied by convection with respect to the ambient heat. However, this requires large heat-convection surfaces, according to the demand for the vaporized gas. Moreover, such systems are incapable of delivering gas at pressures exceeding that of the tank pressure.

In another known system, an external vaporizer is used to heat and vaporize the liquefied gas, with the vaporized gas being recirculated to the storage tank. The vaporized gas supplied to the consumer is delivered via a separate line connected to the storage tank, according to consumer demand. The recirculation of vaporized gas requires a large installation, and correspondingly high investment cost and maintenance expenses. Alternatively, the vaporized gas can be delivered directly to the consumer. However, various mechanical and control-related failures, as well as reduced consumer demand, can cause liquid-phase liquefied gas to be introduced to or to be condensed in the consumer delivery line. Liquid-phase liquefied gas in the vaporized gas is a major problem for many consumers. Consequently, such a process scheme generally requires the addition of vapor/liquid separation equipment for providing the consumer with solely vaporized gas. This equipment increases system complexity, size and cost, and introduces additional reliability and safety problems.

In the parent application, now U.S. Pat. No. 6,470,690, which is hereby incorporated for all purposes as if fully set forth herein, a system and method are disclosed in which the liquefied gas is circulated through an external heat exchanger and returned to the storage tank as a heated liquid. The sensible heat of the heated liquefied gas provides all of the requisite heat for vaporizing the gas (or at least a substantial portion thereof), which occurs within the storage tank. The vaporized gas is delivered via a separate vapor line connected to the storage tank, according to consumer demand.

The above-described system has numerous advantages with respect to other known systems. One important advantage is that the system enables major electrical components to be located remotely from the storage tank. This safety advantage is of particular importance due to the flammable nature of the gases disposed within and delivered from the storage tank.

In some applications, however, it is impractical to install an external heat exchanger through which liquefied gas is pumped.

It would, therefore, be highly advantageous to have a method and a system for supplying vaporized gas on consumer demand without a circulation of liquefied gas external to the storage tank, and without the requisite equipment therefor. It would be of further advantage if the system would allow for improved fire safety with respect to prior-art systems, by enabling all electrical components to be located remotely from the storage tank. It would be of yet further advantage if such a system would be simple and energy-efficient.

### SUMMARY OF THE INVENTION

The present invention is a method and a system for supplying pressurized gas from a liquefied-gas (LG) storage tank.

According to one aspect of the invention, the method includes the steps of: (a) providing a system including: (i) a storage tank for storing liquefied gas, the tank having a lower liquid region and a vapor region thereover; (ii) a heat exchanger external to the storage tank, disposed in a heat-exchange relationship with a wall of the storage tank; (iii) a device for delivering a heat-exchange liquid from a reservoir to the heat exchanger, and (iv) a, delivery line for directly transferring the combustible vaporized gas from the heat exchanger to the consumer; (b) supplying the vaporized gas directly to the consumer, according to consumer demand; (c) upon vaporization of a portion of the liquefied gas within the storage tank, and subsequent cooling of the liquefied gas within the storage tank, transferring heat from the heat-exchange liquid to the storage tank by means of the heat exchanger, so as to increase the pressure within the storage tank.

According to further features in the described preferred embodiments, the method further includes the step of (d) heating the reservoir to supply the heat-exchange liquid with the requisite heat for transferring to the storage tank.

According to still further features in the described preferred embodiments, the method further includes the step of: (e) circulating the heat-exchange liquid between the reservoir and the heat exchanger.

According to still further features in the described preferred embodiments, the system further includes a first line for delivering the heat-exchange liquid to the heat exchanger, and a second line for returning the heat-exchange liquid from the heat exchanger to the reservoir.

According to still further features in the described preferred embodiments, the method further includes the step of: (f) measuring a temperature of the heat-exchange liquid in'the second line, to obtain a measured temperature.

According to still further features in the described preferred embodiments, the method further includes the step of: (g) heating the reservoir based on the measured temperature of the heat-exchange liquid in the second line.

According to still further features in the described preferred embodiments, the method further includes the step of: (g) controlling the device for delivering the heat-exchange liquid based on the measured temperature of the heat-exchange liquid in the second line.

According to still further features in the described preferred embodiments, the method further includes the step of: (f) measuring a pressure within the delivery line to obtain a vapor pressure measurement.

According to still further features in the described preferred embodiments, the method further includes the step of: (g) controlling the transfer of heat from the heat-exchange liquid to the storage tank based on the vapor pressure measurement.

According to another aspect of the present invention there is provided a gas supply system for supplying a combustible vaporized gas to a consumer, according to consumer demand, the gas supply system including: (a) a storage tank for storing liquefied gas, having a lower liquid region and a vapor region thereover; (b) a heating system for providing heat to the storage tank, including: (i) a heat exchanger external to the storage tank, the heat exchanger disposed in a heat-exchange relationship with a wall of the storage tank; (ii) a reservoir for storing a heat-exchange liquid for the heat exchanger; (iii) a first line connecting the reservoir and the heat exchanger, and a second line for returning the heat-exchange liquid from the heat exchanger to the reservoir, and (iv) a pumping device for delivering the heat-exchange liquid from the reservoir to the heat exchanger, via the first line; (c) a delivery line for transferring the vaporized gas from the storage tank to the consumer, and (d) a control system associated with the heating system and configured to control a heat supply to the storage tank, by means of the heat-exchange liquid, such that the storage tank produces the vaporized gas at sufficient pressure so as to meet the consumer demand.

According to further features in the described preferred embodiments, the control system includes a temperature sensor for measuring a temperature of the heat-exchange liquid returning to the reservoir.

According to still further features in the described preferred embodiments, the heating system includes a heating element for heating the reservoir.

According to still further features in the described preferred embodiments, the control system effects the control by operating the heating element based on the temperature measured by the sensor.

According to still further features in the described preferred embodiments, all electrical components of the gas supply system are disposed remotely to the storage tank. Preferably, the electrical components should be at least 5 meters from the gas supply system, more preferably, 10-25 meters, and most preferably, more than 25 meters from the gas supply system.

According to still further features in the described preferred embodiments, the delivery line has a pressure sensor for measuring a vapor pressure of the vaporized gas in the delivery line.

According to still further features in the described preferred embodiments, the control system controls the heating system based on the vapor pressure measured by the pressure sensor.

According to still further features in the described preferred embodiments, if the vapor pressure measured by the sensor exceeds a pre-determined value, the control system reduces or completely curtails the heat supply to the storage tank.

According to still further features in the described preferred embodiments, if the vapor pressure measured by the sensor exceeds a pre-determined value, the control system controls the pumping device so as to reduce or completely curtail the heat supply to the storage tank.

According to still further features in the described preferred embodiments, the heat exchanger includes a flexible heat transfer plate for disposing against an external wall of the storage tank.

According to still further features in the described preferred embodiments, the heat exchanger further includes a pipe containing the heat-exchange liquid, the pipe being fluidly connected to the first line, and disposed in heat-exchange relation to the flexible heat transfer plate.

According to still further features in the described preferred embodiments, the heat transfer plate is a corrugated heat transfer plate.

According to still further features in the described preferred embodiments, the heat-exchange liquid includes water.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a block diagram illustrating a system for supplying vaporized gas according to the parent application, U.S. Pat. No. 6,470,690, and

FIG. 2 is a schematic diagram illustrating one embodiment of a system for supplying vaporized gas according to the present invention;

FIG. 3a is a top, schematic, partially cut-away view of a heating blanket for use in conjunction with the system of the present invention, and

FIG. 3b is a side view of the heating blanket of FIG. 3a.

### DESCRIPTION OF THE PREFERRED EMBODIMENTS

The principles and operation of the system in the invention according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawing. The invention is capable of other embodiments or of being practiced or carried out in various ways. Also, it is to be understood that the phraseology and terminology employed herein is for the purpose of description and should not be regarded as limiting.

As used herein in the specification and in the claims section that follows, the term “liquid” refers to a non-explosive and, preferably, a non-inflammable liquid.

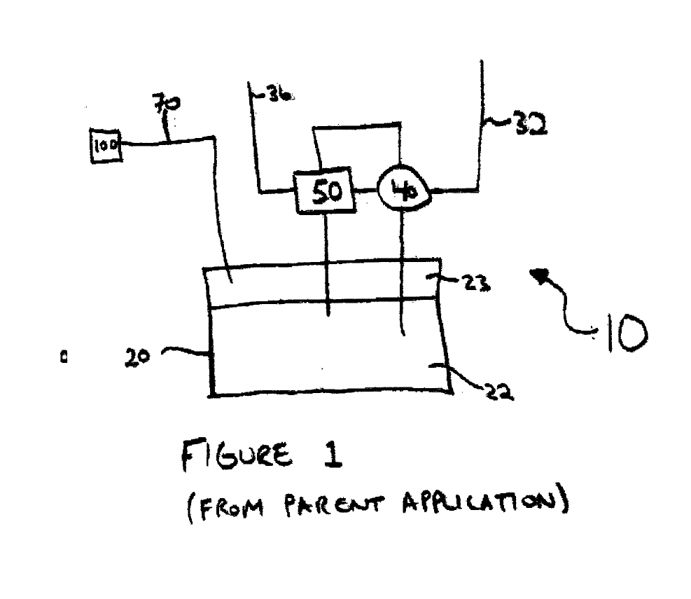

Referring now to the drawings, FIG. 1 is a block diagram illustrating a vaporization system 10 for vaporizing gas according to the parent application, U.S. patent application Ser. No. 09/674,700, now U.S. Pat. No. 6,470,690. A storage tank 20 contains gas, such as propane or butane, in liquefied form, in a lower region 22. Upper region 23, which is in fluid contact with lower region 22, contains gas in vapor form. Liquefied gas from lower region 22 is circulated, preferably by a water-driven turbine pump 40, through a heat exchanger 50. The liquefied gas is heated in heat exchanger 50, the heating being controlled such that the liquefied gas is returned in liquid form to storage tank 20. The sensible heat of the heated liquefied gas provides all of the requisite heat for vaporizing the gas, or at least a substantial portion thereof. The vaporized gas, produced in storage tank 20, is delivered to a consumer 100, according to demand, via a separate vapor line 70 connected to storage tank 20.

Heat exchanger 50 is a surface heat exchanger typically using water as the heat exchange liquid. The water, which is heated and pressurized externally to vaporization system 10, is introduced to heat exchanger 50 via line 36. The water exiting heat exchanger 50 can also serve to drive water-driven turbine pump 40, before leaving system 10 via line 32.

The above-described system has numerous advantages with respect to other known systems. One important advantage is that the system enables major electrical components to be located remotely from the storage tank. This safety advantage is of particular importance due to the flammable nature of the gases disposed within and delivered from the storage tank.

In some applications, however, it is impractical to install an external heat exchanger through which liquefied gas is pumped. Hence, it would be advantageous to have a system for supplying vaporized gas on consumer demand without a circulation of liquefied gas external to the storage tank, and without the requisite equipment therefor. It would be of further advantage if the system would allow for improved fire safety with respect to prior-art systems, by enabling all electrical components, including electrical actuators and indicators, to be located remotely from the storage tank.

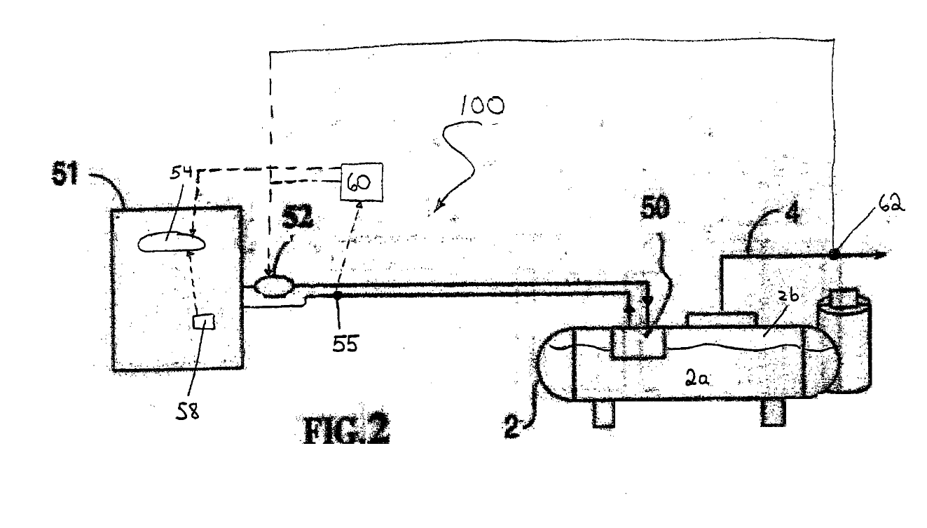

FIG. 2 illustrates a storage tank 2 that is heated by a heating system 100 of the present invention, which includes a remote water heater 51, a heating blanket 50, a circulation pump 52, temperature indicator 55, and optionally, CPU 60. Heating blanket 50, which is directly applied to the external surface of the storage tank, is heated by hot water circulated to heating blanket 50 via a circulation pump 52. A remote water heater 51, typically gas-fired or electric, heats the circulated water to heating blanket 50.

Heating blanket 50 may be disposed substantially anywhere on the body of storage tank 2. However, it is generally preferable to position heating blanket 50 towards the bottom of storage tank 2, well below the interface between liquid region 2a and vapor region 2b within storage tank 2.

Heating system 100 is designed to provide heat to storage tank 2, so as to vaporize the requisite amount of fuel upon consumer demand. Remote water heater 51 supplies heat to the liquefied gas in storage tank 2, along with the influx of ambient heat to boost the internal heat of the liquefied gas within, the storage tank, so as to provide the heat of vaporization for vaporizing, within the storage tank, the liquefied gas, according to the consumer demand therefor.

In simplest form, heating system 100 is controlled as follows: the temperature within remote water heater 51 is controlled by thermostat 58, which is electrically connected to remote water heater 51. Temperature indicator 55 is preferably disposed in the flow of water returning from heating blanket 50 to remote water heater S1. As long as the temperature measured by temperature indicator 55 is below a predetermined value assigned to thermostat 58, remote water heater 51 is heated by heating element 54, such that the water pumped from water heater 51 to heating blanket 50 is relatively hot, enabling substantial heat transfer, via heating blanket 50, to storage tank 2. When the temperature measured by temperature indicator 55 reaches a predetermined value, the heating of remote water heater 51 by heating element 54 is curtailed, such that the transfer of heat to storage tank 2 is gradually reduced, and the temperature of the water within heating blanket 50 approaches the temperature of the liquefied gas within storage tank 2.

When consumer demand resumes or increases, vaporized gas is discharged from storage tank 2 via consumer gas line 4. Liquefied gas within liquid region 2a vaporizes, with the heat of vaporization being drawn from the liquefied gas. Consequently, the temperature within storage tank 2 is decreased. The increased AT between heating blanket 50 and storage tank 2 results in an increased transfer of heat from heating blanket 50 to storage tank 2. The temperature in the return flow decreases, such that the temperature measured by temperature indicator 55 falls below the pre-determined value assigned to thermostat 58, and heating element 54 is activated to heat the water delivered to heating blanket 50.

While the activation of thermostat 58 has been described as a simple on-off control, it will be apparent to one skilled in the art that various known programs for activating thermostat 58 could be used. In addition, in some applications, particularly those in which remote water heater 51 is maintained at a relatively constant temperature, the rate of heat delivered by heating blanket 50 to storage tank 2 can be controlled by controlling the flowrate provided by circulation pump 52.

In many of the prior-art systems for heating gas storage tanks, an external evaporator vaporizes a stream of liquefied gas as long as consumer demand is maintained. This type of system is extremely inefficient from an energy standpoint, because the energy-intensive evaporation is linked to consumer demand, and not to the intrinsic thermodynamic properties of the gas in the system. In a preferred embodiment of the present invention, a pressure indicator or switch 62, disposed on consumer gas line 4, is operatively connected to heating system 100. When the pressure measured by pressure switch 62 is above a pre-determined value, pressure switch 62 deactivates heating system 100, because the pressure of the vaporized gas supplied to the consumers via consumer gas line 4 is sufficiently high. As demand continues, the pressure in consumer gas line 4 is reduced, until the pressure measured by pressure switch 62 drops below a pre-determined value, at which point pressure switch 62 activates heating system 100, which then provides heat to storage tank 2 as described hereinabove.

Pressure switch 62 may directly or indirectly activate and deactivate circulation pump 52. Preferably, heating system 100 is configured such that the deactivation of circulation pump 52 deactivates, in turn, heating element 54. Similarly, when circulation pump 52 is activated, the heating of remote water heater 51 by heating element 54 is enabled.

In another embodiment of the present invention, CPU 60 receives a data signal from temperature indicator 55, and is pre-programmed to control heating element 54 (and/or circulation pump 52) based upon the value received. In addition, CPU 60 may be configured to receive a data signal from pressure indicator or switch 62, and to activate or deactivate heating element 54 (and/or circulation pump 52) based upon the data signal received.

It will be evident to one skilled in the art that many other control relationships between pressure switch 62 and heating system 100 are possible. It must be emphasized, however, that the control of heating system 100 is by no means trivial. The design criteria include:

Minimization of safety risks associated with electrically-powered components in the vicinity of a system containing inflammable or explosive gases

Quick response to consumer demand

Ability to cope with periods in which there is no consumer demand in a safe and energy-efficient manner

Substantially 100% reliability

The system illustrated in FIG. 2 is particularly useful in underground storage tanks, and involves a minimal modification to the existing equipment, both in terms of equipment and in terms of ease of installation.

It must be emphasized that various designs and configurations for achieving the requisite heat-exchange relation will be apparent to those skilled in the art.

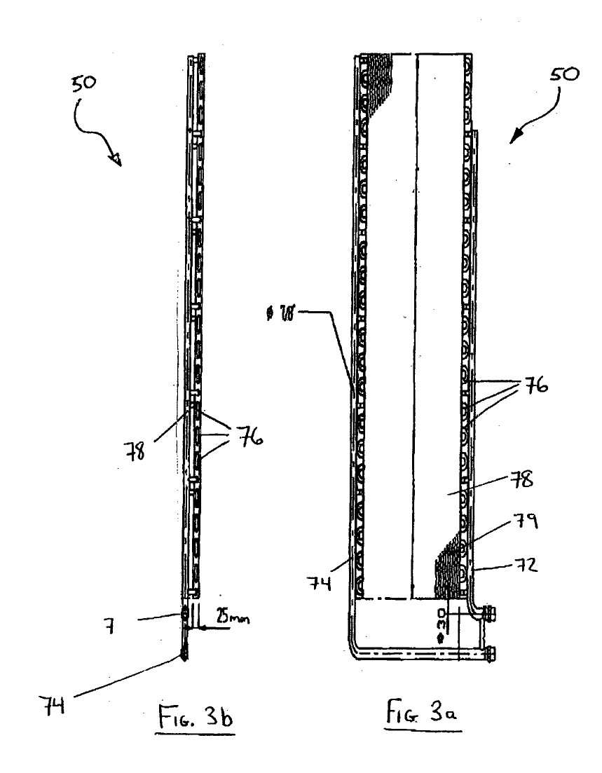

FIG. 3a is a top, schematic, partially cut-away view of heating blanket 50, which includes an inlet tube 72 for supplying hot water for heating the storage tank, an outlet tube 74 for returning water to the reservoir, a serpentine tube 76 connecting between inlet tube 72 and outlet tube 74, and a flexible, conductive mat or plate 78. The difference between the temperature of the water flowing through serpentine tube 76 and the temperature of the liquefied gas in the storage tank provides the driving force for the transfer of heat from the water, through the wall of serpentine tube 76, via conductive plate 78, to the wall of the storage tank, and from there, to the liquefied gas contained therein. Conductive plate 78 is typically made of aluminum, and preferably has a corrugated surface 79 to provide for an increased surface area for heat transfer. The flexibility of conductive plate 78 allows for a good fit with the external wall of the storage tank, such that efficient heat transfer is achieved.

A side view of heating blanket 50 of FIG. 3a is provided in FIG. 3b. It should be appreciated that the thin, compact heating blanket 50 described herein is advantageously installed in new gas storage systems, and is also advantageously retrofitted in existing gas storage systems.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, no citation or identification of any reference in this application shall be construed as an admission that such reference is available as prior art to the present invention.

What is claimed is:

1. A method for supplying a combustible vaporized gas to a consumer, the method comprising the steps of:
(a) providing a system including:
(i) a storage tank for storing liquefied gas, said tank having a lower liquid region and a vapor region thereover;
(ii) a heat exchanger external to said storage tank, said heat exchanger disposed in a heat-exchange relationship with a wall of said storage tank;
(iii) a device for delivering a heat-exchange liquid from a reservoir to said heat exchanger, and
(iv) a delivery line for directly transferring the combustible vaporized gas from said heat exchanger to the consumer;
(b) supplying the vaporized gas directly to the consumer, according to consumer demand, and
(c) upon vaporization of a portion of said liquefied gas within said storage tank, and subsequent cooling of said liquefied gas within said storage tank, transferring heat from said heat-exchange liquid to said storage tank by means of said heat exchanger, so as to increase a pressure within said storage tank.

2. The method of claim 1, further comprising the step of:
(d) heating said reservoir to supply said heat-exchange liquid with a requisite heat for transferring to said storage tank.

3. The method of claim 2, further comprising the step of:
(e) circulating said heat-exchange liquid between said reservoir and said heat exchanger.

4. The method of claim 3, wherein said system further includes a first line for delivering said heat-exchange liquid to said heat exchanger, and a second line for returning said heat-exchange liquid from said heat exchanger to said reservoir.

5. The method of claim 4, further comprising the step of:
(f) measuring a temperature of said heat-exchange liquid in said second line, to obtain a measured temperature.

6. The method of claim 5, further comprising the step of:
(g) heating said reservoir based on said measured temperature of said heat-exchange liquid in said second line.

7. The method of claim 5, further comprising the step of:
(g) controlling said device for delivering said heat-exchange liquid based on said measured temperature of said heat-exchange liquid in said second line.

8. The method of claim 3, wherein all electrical components of said system are disposed remotely to said storage tank.

9. The method of claim 3, wherein said heat-exchange liquid includes water.

10. The method of claim 3, further comprising the step of:
(f) measuring a pressure within said delivery line to obtain a vapor pressure measurement.

11. The method of claim 10, further comprising the step of:
(g) controlling said transferring heat from said heat-exchange liquid to said storage tank based on said vapor pressure measurement.

12. A gas supply system for supplying a combustible vaporized gas to a consumer, according to consumer demand, the gas supply system comprising:
(a) a storage tank for storing liquefied gas, said tank having a lower liquid region and a vapor region thereover;
(b) a heating system for providing heat to said storage tank, said heating system including:
(i) a heat exchanger external to said storage tank, said heat exchanger disposed in a heat-exchange relationship with a wall of said storage tank;
(ii) a reservoir for storing a heat-exchange liquid for said heat exchanger;
(iii) a first line connecting said reservoir and said heat exchanger, and a second line for returning said heat-exchange liquid from said heat exchanger to said reservoir, and
(iv) a pumping device for delivering said heat-exchange liquid from said reservoir to said heat exchanger, via said first line;
(c) a delivery line for transferring the vaporized gas from said storage tank to the consumer, and
(d) a control system associated with said heating system and configured to control a heat supply to said storage tank, by means of said heat-exchange liquid, such that said storage tank produces the vaporized gas at sufficient pressure so as to meet the consumer demand.

13. The gas supply system of claim 12, wherein said control system includes a temperature sensor for measuring a temperature of said heat-exchange liquid returning to said reservoir.

14. The gas supply system of claim 13, wherein said heating system includes a heating element for heating said reservoir.

15. The gas supply system of claim 14, wherein said control system effects said control by operating said heating element based on said temperature measured by said sensor.

16. The gas supply system of claim 12, wherein all electrical components of the gas supply system are disposed remotely to said storage tank.

17. The gas supply system of claim 12, wherein said delivery line has a pressure sensor for measuring a vapor pressure of the vaporized gas in said delivery line.

18. The gas supply system of claim 17, wherein said control system controls said heating system based on said vapor pressure measured by said pressure sensor.

19. The gas supply system of claim 17, wherein if said vapor pressure measured by said sensor exceeds a pre-determined value, said control system at least reduces said heat supply to said storage tank.

20. The gas supply system of claim 17, wherein if said vapor pressure measured by said sensor exceeds a pre-determined value, said control system controls said pumping device so as to at least reduce said heat supply to said storage tank.

21. The gas supply system of claim 12, wherein said heat exchanger includes a flexible heat transfer plate for disposing against an external wall of said storage tank.

22. The gas supply system of claim 21, wherein said heat exchanger further includes a pipe containing said heat-exchange liquid, said pipe fluidly connected to said first line, said pipe disposed in heat-exchange relation to said flexible heat transfer plate.

23. The gas supply system of claim 21, wherein said heat transfer plate is a corrugated heat transfer plate.
